(19) United States
(12) Patent Application Publication
(10) Pub. No.: US 2022/0062797 A1
(43) Pub. Date: Mar. 3, 2022

(54) VARIABLE-POROSITY FILTERING APPARATUS HAVING COMPRESSIBLE FILTERING MEDIUM

(71) Applicant: EXTERRAN WATER SOLUTIONS ULC, Calgary (CA)

(72) Inventor: Todd William KIRK, Rockyview County (CA)

(21) Appl. No.: 17/465,700

(22) Filed: Sep. 2, 2021

Related U.S. Application Data
(60) Provisional application No. 63/073,925, filed on Sep. 2, 2020.

(51) Int. Cl. B01D 24/04; B01D 39/04; B01D 24/46

(52) U.S. Cl. CPC B01D 24/042; B01D 15/361; B01D 24/4663; B01D 39/04

(57) ABSTRACT

A filtering apparatus has a volume-changeable filtering chamber having one or more flexible enclosing walls and receiving therein a compressible porous filtering medium, a fluid inlet coupled to the filtering chamber for introducing an input fluid stream with impurities into the filtering chamber, a fluid outlet coupled to the filtering chamber for discharging a filtered fluid stream from the filtering chamber, and a volume-changing structure coupled to or in association with the filtering chamber, adapted to permit increasing or decreasing of the volume of the filtering chamber so as to compress or decompress the compressible porous filtering medium therein so as to correspondingly adjust the pore size of the compressible porous filtering medium in said filtering chamber. A method for flushing a compressible filter media, and a method of variably adjusting the amount of filtering, is further disclosed and claimed.

### FIELD OF THE DISCLOSURE

The present disclosure relates generally to a filtering apparatus and method for purifying contaminated liquid mediums, and in particular to a filtering apparatus having a compressible filtering medium of variable porosity.

### BACKGROUND

Filtering devices using porous media are known. Generally, such a filtering device comprises one or more layers of porous media for filtering or otherwise removing the impurities in a fluid stream. The porous media comprise a specific pore size greater than that of the fluid molecules to allow the fluid to pass therethrough, but smaller than that of the impurities to retain the impurities in an accumulation area on the inlet side of the porous media.

Traditional filtering devices usually provide for fixed filter beds of porous media having fixed pore sizes (interstitial spaces between the media particulates or media material). However, typically one needs to replace filtering devices with different pore sizes when filtration of different impurities is needed.

Filtering devices with adjustable pore sizes are also known. For example, European Patent Application Ser. No. 2,638,940, entitled “Water-conducting domestic appliance with an adjustable filter”, to Bischof, et al. teaches a filter having an elastically deformable filter layer, which is provided with several open recesses. The elastically deformable filter layer is stretched and/or is compressible. The open recesses are extended vertically to filter sides of the filter layer. The elastically deformable filter layer is stretched and/or is compressible along the respective extending direction of the open recesses.

PCT Patent Application Ser. No. PCT/KR02/00308, entitled “Pore size controllable filter”, to Kang teaches a pore-size controllable filter for separating and removing the suspended solid and eliminating the solid captured by the device. The filtering materials are built on the upper filtering material holder and the lower filtering material holder of radial type facing each other at a certain distance in the filtering tub, forming a filtering layer. According to the direction and the degree of rotation of the upper handle connected to the upper rotation axis, the filtering materials come together to the center along the upper filtering material holder and the lower filtering material holder. Then one side or both sides are twisted in opposite directions and concentrated around the perforated pipe located at the central axis or restored to the original state. Accordingly, the size of the pore created between the filtering materials can be adjusted, enabling to conduct filtering and washing operations at a proper level.

U.S. Pat. No. 3,747,769, entitled “Compressible disposable filter press for blood”, to Brumfield teaches an open cell, compressed, elastic plastic foam filter medium, having average diameter cell pore openings selected values ranging from 25 to 150 microns, disposed as a planar volume in an adjustable disposable filter press. The filter medium is disposed between a pair of rigid filter press plates, which are in turn disposed in the filter press structure. The press can provide an adjustable control means suitable for varying the average diameter of the pore openings, by varying the compression of the filter medium. A flexible, filter press case provide means of assisting blood circulation through the filter medium, and of separating air entrained in the blood in the filter press.

US Patent Application Publication No. 2008/0184881A1, entitled “Mesh-adjustable molecular sieve”, to Zhou, et al. teaches metal-organic framework-based molecular sieves comprising pores with a temperature-adjustable pore opening. The temperature-adjustable pore size molecular sieves comprise a plurality of metal clusters bound with a plurality of amphiphilic ligands, each ligand comprising a functionalized hydrophobic moiety and a functionalized hydrophilic moiety, and wherein the metal clusters and amphiphilic ligand hydrophilic moieties form a metal cluster layer, the metal cluster layer forming at least one hydrophilic pore. On each side of the metal cluster layer, a plurality of associated amphiphilic ligand hydrophobic moieties cooperate with the metal cluster layer to form a tri-layer and a plurality of tri-layers are held in proximity with each other to form at least one hydrophobic chamber. The hydrophobic moieties form temperature-adjustable pore size hydrophobic pores. When adjusted to a pre-selected temperature the temperature-adjustable pore openings allow for the passage of molecules having a size less than the size of the pre-selected temperature-adjustable pore opening.

A need nevertheless exists for a mechanically relatively simple but mechanically reliable apparatus to be able to dynamically adjust pore size to be able to dynamically adjust size of particulate impurities which are removed from a fluid stream, and adapted to be more easily cleaned than existing filter media.

### SUMMARY OF THE INVENTION

According to one aspect of this disclosure, there is provided a filtering apparatus. The filtering apparatus comprises: a volume-changeable filtering chamber having one or more flexible sidewalls and receiving therein a compressible porous filtering medium; a fluid inlet coupled to the filtering chamber for introducing an input fluid stream with impurities into the filtering chamber; a fluid outlet coupled to the filtering chamber for discharging a filtered fluid stream from the filtering chamber; and a volume-changing structure in association with or coupled to the filtering chamber, for adjusting the volume of the filtering chamber for adjusting the pore characteristics of the porous filtering medium.

In some embodiments, the filtering apparatus further comprises: a vessel receiving therein the filtering chamber with the fluid inlet and the fluid outlet extending out of the vessel. The vessel comprises: a pressure-adjustment medium in the annulus between the filtering chamber and the vessel; and a pressure-adjustment port in fluid communication with the annulus between the filtering chamber and the vessel for adjusting the pressure of the pressure-adjustment medium.

In some embodiments, the pressure-adjustment medium is in a particle form.

In some embodiments, the pressure-adjustment medium is crushed walnut shells and/or activated carbon.

According to one aspect of this disclosure, there is provided a filtering apparatus. The filtering apparatus comprises: a volume-changeable filtering chamber having one or more flexible enclosing walls and receiving therein a compressible porous filtering medium; a fluid inlet coupled to the filtering chamber for introducing an input fluid stream with impurities into the filtering chamber; a fluid outlet coupled to the filtering chamber for discharging a filtered fluid stream from the filtering chamber; and a volume-changing structure coupled to or in association with the filtering chamber, adapted to permit increasing or decreasing of the volume of the filtering chamber so as to compress or decompress the compressible porous filtering medium therein so as to correspondingly adjust the pore size of the compressible porous filtering medium in said filtering chamber.

In some embodiments, said filtering chamber and said volume-changing structure comprises a thin, resiliently flexible, elongate hollow member.

In some embodiments, the filtering apparatus further comprises: a vessel receiving therein the filtering chamber with the fluid inlet and the fluid outlet extending out of the vessel. The vessel comprises: a pressure-adjustment medium in an annulus between the filtering chamber and the vessel; and a pressure-adjustment port in fluid communication with the annulus between the filtering chamber and the vessel for adjusting the pressure of the pressure-adjustment medium.

In some embodiments, the pressure-adjustment medium is a fluid.

In some embodiments, the compressible porous filter medium is crushed walnut shells, or extrusion blow moldable thermoplastic vulcanizate such as Viprene™, or an activated carbon material

In some embodiments, (i) the volume-changing structure comprises at least one moveable piston, and the volume of said volume-changing structure may be changed by movement of said piston.

In a further refinement thereof, said volume-changing filtering chamber comprises an elongate bladder formed of a resiliently flexible material; and (iii) said bladder is situated in said volume-changing structure.

In a further broad aspect of the present invention, the invention relates to a method of filtering a fluid containing a contaminant, comprising the steps of:

(i) applying a pressure to an exterior of an elongate resiliently-flexible bladder containing therewithin a compressible filtering medium, so as to compress said compressible filtering medium;

(ii) directing a contaminant-laden fluid stream into an inlet end of said resiliently-flexible bladder, and causing filtered fluid to exit an outlet end of said resiliently-flexible bladder ;

(ii) when desired to flush said compressed filter media, reducing pressure applied to an exterior of said resiliently-flexible bladder and thus reducing pressure applied to said filter media in said resiliently-flexible bladder and permitting said compressible media in said resiliently-flexible bladder to expand; and

(iii) directing a flushing fluid into said outlet end of said resiliently-flexibile bladder and causing said flushing fluid to exit said inlet end of said resiliently-flexible bladder.

Advantageously, where temporarily reducing the compression applied to the resiliently flexible bladder and thus temporarily reducing the compression applied to the filter media contained therein, a temporary increase in the size of the interstitial pores allows in the filter media can be obtained, which thereby allows better reverse flushing of the compressible filter media using a flushing fluid.

Thereafter, normal filtering can then be efficiently resumed as if the filter was new and there is no or little reduction to the filtering capacity of the filter material when it then is compressed to resume filtering operation, as the interstitial pores of the filtering fluid have been effectively flushed of filtered contaminant.

In a further refinement of the above method, the step of reducing pressure to said resiliently-flexible bladder comprises reducing a pressure of fluid which is supplied to a region surrounding an exterior of said resiliently-flexible bladder.

In an alternative refinement to the method of the present invention, the step of reducing pressure to said elongate hollow bladder comprises the step of reducing a force that a moveable piston is applying against a portion of said resiliently-flexible bladder.

In another broad aspect of the present invention, a method of adjustably changing the amount of filtration of a contaminated fluid is provided, comprising the steps of:

(i) applying a pressure to an exterior of an elongate resiliently-flexible bladder containing therewithin a compressible filtering medium, so as to compress said compressible filtering medium;

(ii) directing a contaminant-laden fluid stream into an inlet end of said resiliently-flexible bladder, and causing filtered fluid to exit an outlet end of said resiliently-flexible bladder;

(ii) when desired to reduce a concentration of contaminant in said contaminant-laden fluid stream, increasing pressure applied to about an exterior of said resiliently-flexible bladder and thus increase pressure applied to said filter media in said resiliently-flexible bladder so as to further compress said filter media in said resiliently-flexible bladder.

Advantageously, such further refinement allows real-time customization of the filter media to immediately increase filtering capability when contaminants of a smaller size are detected in a contaminant stream being filtered, without having to stop the contaminated fluid stream, change out the filter to one of decreased pore size, before being able to continue to resume filtering of a contaminated fluid stream.

### BRIEF DESCRIPTION OF THE DRAWINGS

FIG. 1 is a schematic cross-sectional view of a filtering apparatus, according to some embodiments of this disclosure, wherein the filtering apparatus comprises a vessel receiving therein a volume-changeable filtering chamber filled with a porous filtering medium;

FIG. 2 is a schematic cross-sectional view of the filtering apparatus shown in FIG. 1, wherein the volume of the filtering chamber is reduced for increasing the porosity and/or reducing the pore size of the porous filtering medium;

FIG. 3 is a schematic cross-sectional view of the filtering apparatus shown in FIG. 1, wherein the volume of the filtering chamber is adjusted for adjusting the porosity and/or the pore size of the porous filtering medium;

FIG. 4 is a schematic cross-sectional view of the filtering apparatus shown in FIG. 1, wherein the volume of the filtering chamber is increased for reducing the porosity and/or increasing the pore size of the porous filtering medium for flushing;

FIG. 5 is a perspective view of a filtering apparatus, according to some embodiments of this disclosure;

FIG. 6 is a front view of the filtering apparatus shown in FIG. 5;

FIG. 7 is a plan view of the filtering apparatus shown in FIG. 5 with broken lines illustrating the internal structure thereof;

FIG. 8 is a side view of the filtering apparatus shown in FIG. 5 with broken lines illustrating the internal structure thereof;

FIG. 9 is an enlarged cross-sectional view of the section A of the filtering apparatus shown in FIG. 8;

FIG. 10 is a schematic cross-sectional view of a filtering apparatus, according to some embodiments of this disclosure;

FIGS. 11A and 11B are cross-sectional views along a lateral direction of the filtering apparatus shown in FIG. 10, wherein the filtering apparatus is configured at different compression levels;

FIGS. 12A and 12B are cross-sectional views along a lateral direction of the filtering apparatus, according to some embodiments of this disclosure, wherein the filtering apparatus is configured at different compression levels;

FIG. 13 is a schematic drawing of the test equipment used in tests conducted and described herein;

FIG. 14 is a graphical depiction of data obtained showing the relationship between media porosity, and overburden pressure (media compression) for an industry-standard media ‘A” (crushed walnut shells) and a more compressible media (Viprene™);

FIG. 15 is a graphical depiction of data obtained showing the relationship between media compression with respect to 3 different compression pressures (1, 20, and 40 psi) for an industry standard media (crushed walnut shells) and the amount of contaminant (in ppm) at filter outlet, all as a function of time; and

FIG. 16 is a graphical depiction of data obtained showing the relationship between the remaining concentration in ppm at the filter outlet, over time, with respect to two different filter media ‘A’ and ‘B’, at a common overburden pressure of 20 psi.

### DETAILED DESCRIPTION OF SOME PREFERRED EMBODIMENTS OF THE INVENTION

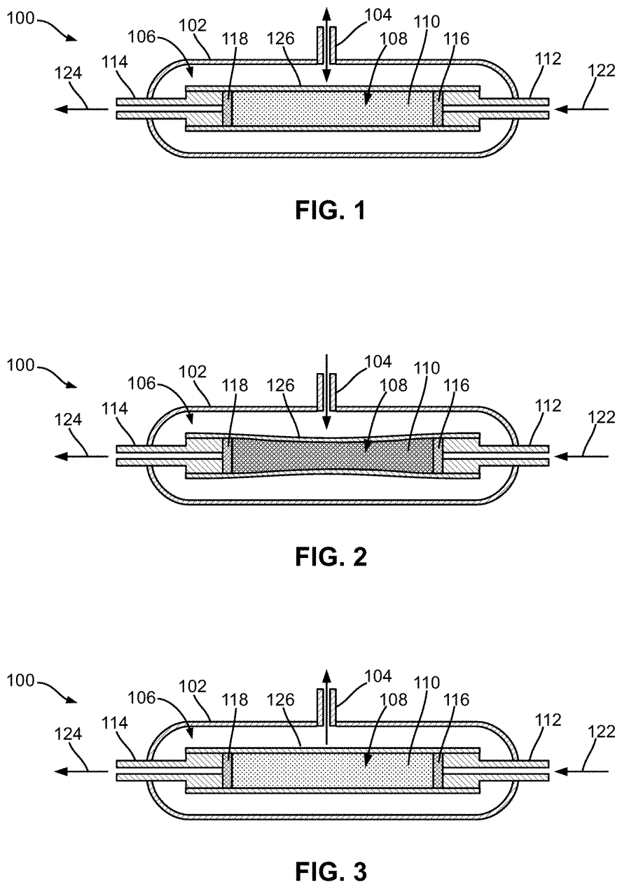

With reference to FIG. 1, a filtering apparatus is shown, generally identified by reference numeral 100. As shown, the filtering apparatus 100 comprises an outer vessel 102 having a pressure-adjustment port 104 and receiving therein a filtering structure 106.

The pressure-adjustment port 104 is in fluid communication with a suitable pressuring device such as a pump (not shown) for adjusting the pressure in the outer vessel using a suitable pneumatic or hydraulic pressure-adjustment medium. For example, in some embodiments, the pressure-adjustment medium may be a suitable gas-phase medium such as air, CO₂, N₂, and/or the like. In some other embodiments, the pressure-adjustment medium may be a suitable liquid-phase medium such as water, oil, and/or the like.

The filtering structure 106 comprises a filtering chamber 108 receiving therein a porous filtering medium 110. The filtering chamber 108 is coupled to and in fluid communication with a fluid inlet 112 and a fluid outlet 114 via an inlet screen 116 and an outlet screen 118, respectively. The fluid inlet 112 extends out of the outer vessel 102 for receiving a “contaminated” input fluid stream 122 having a target fluid with impurities, and injecting the input fluid stream 122 into the filtering chamber 108 via the inlet member 116, which retains the filter medium 110 in close proximity thereto so as to be able to resist the downstream force of pressurized inlet fluid being introduced to the filter medium 110. The fluid outlet 114 extends out of the outer vessel 102 for discharging out of the vessel 102 via the outlet member 118 which likewise retains the filter medium 110 in close proximity thereto so as to be able to resist the reversed force of pressurized fluid being introduced to the filter medium 110 during a cleaning cycle During normal operation, however, the fluid outlet generally receives a filtered stream generally comprising the target fluid but substantially without the impurities originally entrained in such target fluid.

In these embodiments, the input fluid stream 122 may be a liquid such as water, oil, and/or the like, with solid impurities. However, those skilled in the art would appreciate that, in other embodiments, the input fluid stream 122 may be in any suitable form. For example, the target fluid may be gas and/or liquid. The impurities may be gas, liquid, and/or solids or combinations thereof.

The filtering medium 110 may be a suitable material for forming a porous volume in the filtering chamber 108 for filtering the solid impurities from the liquid, with the pore structure, shape, size, and/or porosity being adjustable under pressure or upon changing of the volume of the filtering chamber 108.

In some embodiments, the filtering medium 110 may be in the form of particles such as crushed walnut shells, activated carbon, and/or the like, with suitable shapes, sizes, and/or compressibilities which, when located in the filtering chamber 108, may form a porous layer, or volume with the particle density thereof and thus the pore characteristics thereof being variably adjustable upon application of pressure or upon changing of the volume of the filtering chamber 108.

In some embodiments, the filtering medium 110 may be in the form of one or more spongy materials deformable under pressure, such as Viprene™, such being a trademark of Alliance Polymers and Services Ltd. of Westand, Mich. for an extrusion blow-moldable thermoplastic vulcanizate that can be press blow molded, suction blow molded, or 3D sequential coextruded, so as to be comprised of a plurality of micron-sized pores substantially uniformly dispersed throughout.

In these embodiments, the flexible exterior 126 of the filtering chamber 108 is impermeable with respect to the input fluid stream 122, and is volume-changeable under external pressure for adjusting the pore structure, shape, or size, and/or porosity of the filtering medium 110 therein. For example, in the embodiment shown in FIG. 1, the filtering chamber 108 comprises a flexible impermeable tubing member 126 such as a rubber sleeve coupled to the fluid inlet 112 and the fluid outlet 114 on the opposite ends thereof.

The rubber sleeve 126 may change volume under pressure. For example, as shown in FIG. 2, a pump (not shown) may increase the pressure of the pressure-adjustment medium in vessel 102 which in turn compresses the rubber sleeve 126. Consequently, the volume of the filtering chamber 108 is reduced, giving rise to a fine pore size for filtering out small-size impurities in the input fluid stream 122.

As shown in FIG. 3, the pump may decrease the pressure of the pressure-adjustment medium in the vessel 102 which in turn decompresses the rubber sleeve 126. Consequently, the volume of the filtering chamber 108 is increased, giving rise to a large pore size for only filtering out large-size impurities in the input fluid stream 122 (i.e., smaller-size impurities may pass therethrough).

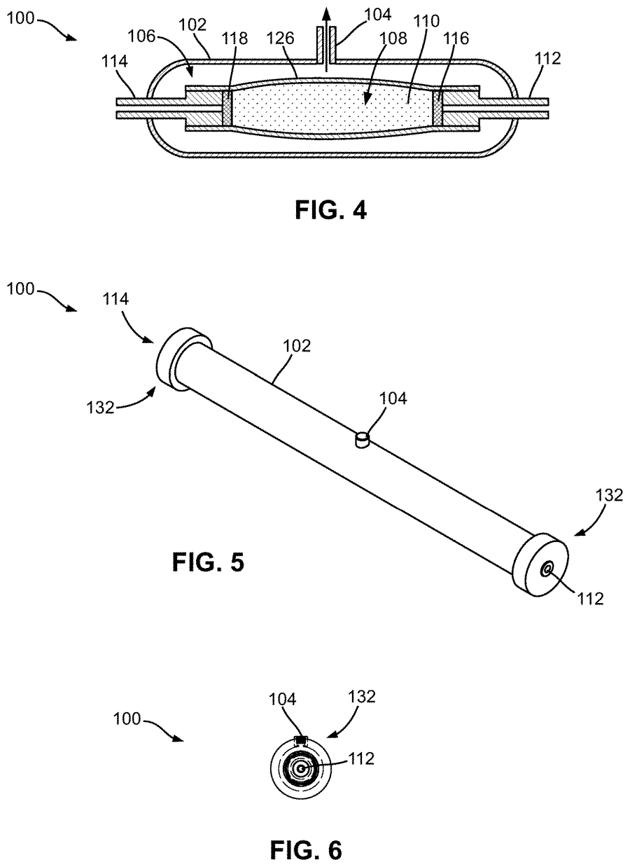

As shown in FIG. 4, the pump may further decrease the pressure of the pressure-adjustment medium in the vessel 102 (e.g., causing a negative pressure in the vessel 102 with respect to the exterior pressure thereof, or even causing a vacuum or near vacuum in the vessel 102), which in turn further decompresses the rubber sleeve 126. Consequently, the volume of the filtering chamber 108 is further increased, giving rise to a larger pore size suitable for flushing or backwash the filtering medium 110.

FIG. 5 is a perspective view of the filtering apparatus 100 according to some embodiments of this disclosure. FIG. 6 is a front view of the filtering apparatus 100 in these embodiments.

As shown, the filtering apparatus 100 comprises a tubular vessel 102 removably coupled to two end couplings 132 and 134 on the opposite ends thereof with one end coupling 132 comprising the fluid inlet 112 and the other end coupling 134 comprising the fluid outlet 114. The tubular vessel 102 comprises a pressure-adjustment port 104 thereon intermediate the fluid inlet and outlet 112 and 114.

In one embodiments, the tubular vessel 102 may be a steel pipe with a length of 48″ (i.e., 48 inches) or 1219 millimeter (mm) and an outer diameter (OD) of 4¼″ or 108 mm. The pressure-adjustment port 104 is a ½″ or 13 mm National Pipe Taper (NPT; American National Standard Taper Pipe Thread) Thredolet® (Thredolet is a registered trademark of Bonney Forge Corporation of Mt Union, Pa., U.S.A.).

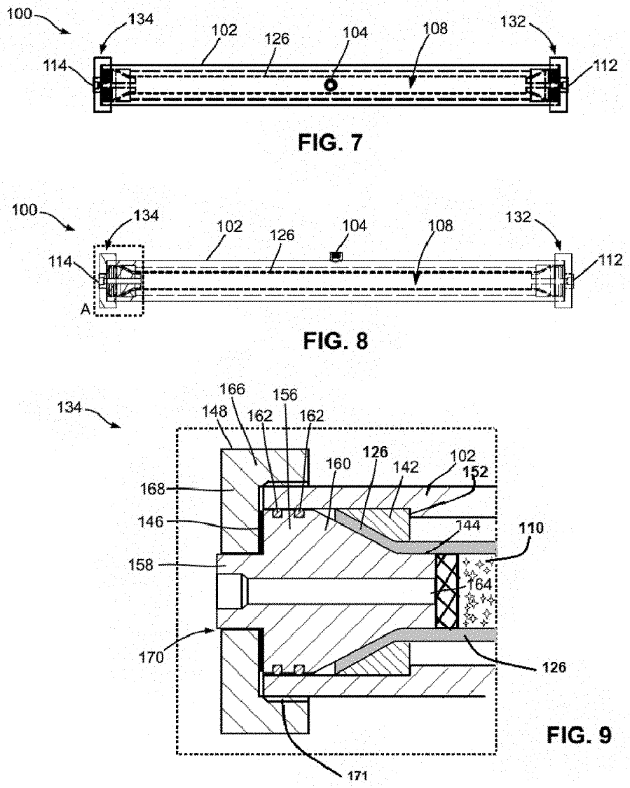

As shown in FIGS. 7 and 8, the tubular vessel 102 is filled with a pressure-adjustment medium (not shown) and receives therein a rubber sleeve 126 removably affixed or otherwise coupled to the end couplings 132 and 134. In some embodiments, the rubber sleeve 126 is made of flexible Viton® rubber (Viton® is a registered trademark of The Chemours Company of Wilmington, Del., U.S.A.) or buna rubber, and has a diameter of about 1.5″, a length of about 45″ and a thickness of about ⅛″ to about ¼″. The rubber sleeve 126 forms the filtering chamber 108 and receives therein the filtering medium 110 which is in fluid communication with the fluid inlet and outlet 112 and 114 via the inlet and outlet members 116 and 118 (not shown).

FIG. 9 shows the detail of the end coupling 134 which has a similar structure as the other end coupling 132. For ease of description, a direction or position along a longitudinal axis of the tubular vessel 102 away from the center of the tubular vessel 102 is denoted a distal direction or position, and a direction or position along the longitudinal axis proximal the center of the tubular vessel 102 is denoted a proximal direction or position.

The end coupling 134 in these embodiments comprises an angled stopper 142, an insert 144, a needle-roller thrust bearing 146, and a threaded pipe cap 148. As shown in FIG. 9, the end of the tubular vessel 102 has an enlarged inner diameter (ID) thereby forming a distal-facing seat 152 for receiving the angled stopper 142. The angled stopper 142 comprises a substantially conical frustum shaped bore with the ID at the distal end thereof greater than that at the proximal end thereof, which is adapted to compress a flared end of flexible impermeable tubing member 126.

The insert 144 comprises a cylindrical main body 156 with an OD slightly smaller than the enlarged ID of the tubular vessel 102, a cylindrical distal end 158 of a smaller OD, and a substantially conical frustum shaped proximal portion 160 with the OD at the distal end thereof greater than that at the proximal end thereof. The insert 144 has suitable dimensions such that, when it is received into the ID-enlarged end of the tubular vessel 102 and the impermeable flexible tubing member, the angled outer surface of the proximal portion 160 forces and traps the flared end of impermeable flexible tubing 126 against s the angled inner surface of the angled stopper 142 to affix an end of the rubber sleeve 126 therebetween. One or more O-rings 162 may be used to seal the insert 144 against the inner surface of the tubular vessel 102. The insert 144 also comprises a longitudinal bore 164 forming the fluid outlet 114. In these embodiments, the fluid outlet 114 (and also the fluid inlet 112) has a diameter of ½″ or 13 mm.

The needle-roller thrust bearing 146 is coupled to the insert 144 about the cylindrical distal end 158 thereof. The threaded pipe cap 148 comprises a sidewall 166 with threads 171 on the inner surface thereof and an end wall 168 having a bore 170 for extending the cylindrical distal end 158 of the insert 144 therethrough. The threaded pipe cap 148 is coupled to the ID-enlarged end of the tubular vessel 102 by engaging the threads 171 on its inner surface with corresponding threads (not shown) on the outer surface of the ID-enlarged end of the tubular vessel 102. The end wall 168 of the threaded pipe cap 148 presses the insert 144 to firmly retain the end of the rubber sleeve 126 in place.

The filtering apparatus 100 in these embodiments may be used for filtering an input fluid such as produced water with a flowrate of about 12 gallons per minute (gpm) per square-foot (gpm/ft²) to about 25 gpm/ft² at approximately 1.5″ diameter. The impurities or contaminant of the input fluid is about 20 parts per million (ppm) to about 100 ppm oil and suspended solids with mean particle-size of about 5 micron (i.e., micrometer, μm) to 25 μm. The pressure difference between the pressure in the tubular vessel 102 (i.e., exterior to the rubber sleeve 126) and that in the rubber sleeve 126 is adjustable between about 10 pounds per square inch (psi) and about 1000 psi.

The operation of the filtering apparatus 100 is similar that described above. In particular, by adjusting the pressure in the tubular vessel 102 via the pressure-adjustment port 104, the volume of the rubber sleeve 126 is thereby varied, thereby adjusting the porosity and/or the pore size of the filtering medium 110 therein for filtering specific sizes of impurities, or for flushing.

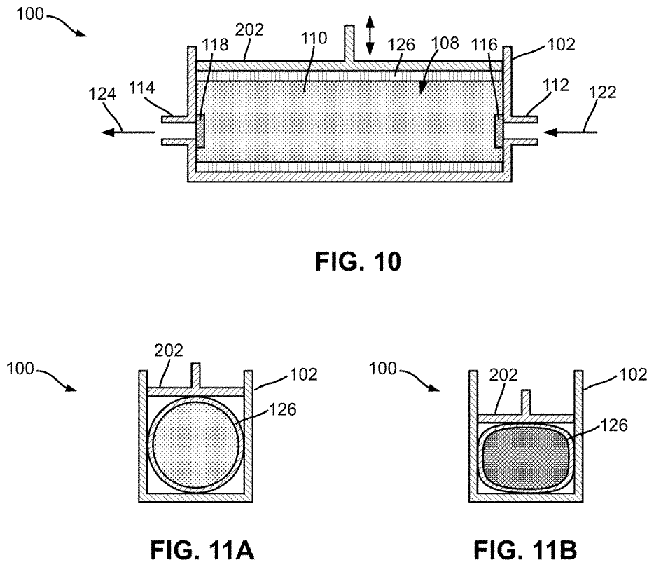

FIG. 10 shows a filtering apparatus 100 in some embodiments. The filtering apparatus 100 in these embodiments is similar to that shown in FIG. 1 except that in these embodiments, a moveable piston 202 is used for changing the volume of the rubber sleeve 126.

Similar to the filtering apparatus in above-described embodiments, in these embodiments, the position of the piston 202 may be adjusted to change the volume of the filtering chamber 108 to compress or decompress the filtering medium 110 within rubber sleeve 126, for thereby adjusting the pore characteristics and pore size of such filtering medium 110 to achieve various filtering performances or for flushing, as shown in FIGS. 11A and 11B. The use of rubber sleeve 126 simplifies the design of the piston 202 by eliminating the need of sealing and/or a wiper (which may be otherwise required for cleaning the inner surface of the vessel 102 for ensuring smooth movement of the piston 202), but in such modified design such rubber sleeve is not necessarily needed, and the filtering chamber 108 may merely contain the compressible filter medium 110.

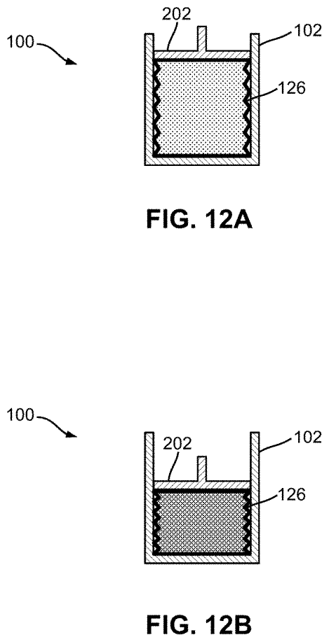

FIG. 12A is a cross-sectional view (along a lateral direction) of a filtering apparatus 100 according to some embodiments of this disclosure. The filtering apparatus 100 in theses embodiments is similar to that shown in FIGS. 10 to 11B except that the rubber sleeve 126 in these embodiments has a rectangular cross-section with foldable sidewalls. Such a rubber sleeve 126 may be advantageous in achieving uniform compression and decompression of the filtering chamber 108 for ensuring uniform density of the filtering medium 110 throughout the filtering chamber 108.

### Experimental Test Equipment and Test Procedure and Results

Test Apparatus and Test Procedure

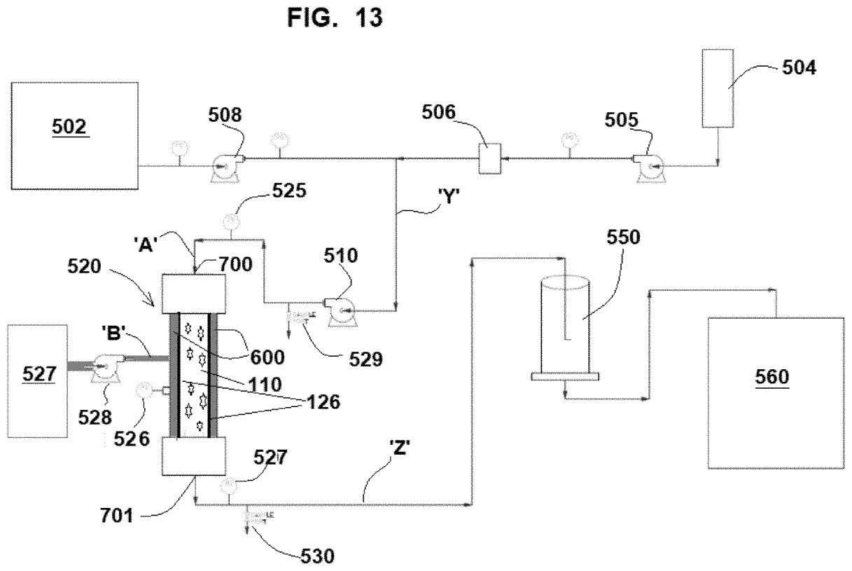

A test apparatus as shown in FIG. 13 hereto was used to confirm a number of hypotheses regarding the operability of the invention.

In the test apparatus used and as shown in FIG. 13, a feed water (tap water) is contained in vessel 502, and was pumped via syringe pump 508 to merge with contaminating fluid (oil) supplied from tank 504 via a similar syringe pump 505. An oil retention regulator 506 was provided to regulate the “oil in water” ratio. To create an oil-in-water emulsion, the mixed water and oil stream “Y” was passed through a variable frequency drive (VFD) controlled vane pump 510, which caused the oil to shear and become entrained in small droplets of size 21-26 microns within the resulting contaminated fluid stream ‘A”. The resulting contaminated fluid stream ‘A’ was supplied to the fluid inlet 700 of one embodiment of the filtering apparatus 520 of the present invention, having a resiliently-flexible bladder 126 containing one of two compressible media 110, in either of two (non-limiting) forms, as shown below:

TABLE 1
(Non-limiting) Compressible Media “A” and “B” Tested:

| | |
|---|---|
| Compressible | Crushed walnut shells, of relatively low |
| Filter | compressibility, of 10-12 mesh size |
| Media “A” | |
| Compressible | an extrusion blow moldable thermoplastic vulcanizate |
| Filter | made by Alliance Polymers And Services, LLC of |
| Media “B” | Romulus, Michigan, marketed under the unregistered |
| | Trademark Viprene ™, of relatively high |
| | compressibility. |
| | Viprene can be press blow molded, suction blow |
| | molded, or 3D sequential coextruded, and be optimized |
| | with specific compressibility or measured hardness, |
| | from a 45A-50D hardness temperatures ranging from |
| | 40° F. to 347° F. while retaining flexibility. |
| | Vipren ™ used was a “series G”, of a hardness of |
| | 45A-50D. |

During forward flow or normal filtering operation, the contaminated fluid stream ‘A’ was directed through fluid inlet 700 in media filtering system 520 where it entered resiliently-flexible bladder 126 formed of synthetic impermeable rubber.

Oil droplet size was measured by the FlowCam 8000 series device made by Fluid Imaging Technologies, and the Oil-In-Water (OIW) concentration (in parts per million “ppm”) was measured by an InfraCal 2 device manufactured by Spectro Scientific. OIW was further validated through the services of an independent third party.

Pressure gauges 525 and 527 were used to measure the differential pressure drop across the filter media 110, they each having been calibrated beforehand with calibration certificates.

Pressure gauge 526 was further used and calibrated to measure the fluid pressure (hereinafter “overburden pressure”) applied to the inner annular space 600 surrounding resiliently-flexible bladder 126, which was used in compressing and decompressing resiliently-flexible bladder 126 to thereby adjust the amount of compression of the filter media 126, and thus adjust the porosity of the filter media 126.

Oil used was API 26, and the average inlet loading to fluid inlet 700 was 50 ppm, with an average inlet oil droplet size of 21-26 microns.

Table II below sets out additional test parameters used, as follows:

TABLE II

| | | |
|---|---|---|
| Inlet Flow rate | 510 | cm³/min |
| Inlet Oil Pump Rate | 0.03 | mL/min |
| Initial Cross-sectional area of filter | 1320 | mm² |
| media in interior of resiliently-flexible | | |

| | |
|---|---|
| bladder 126 | |
| Overburden pressure | Variable (0 psi, 20 psi, 40psi) |
| Temperature | 21-25° C. |

During forward flow, the contaminated fluid “A” was provide to the top fluid inlet 700 of the filter media system 520, flows through the tightly packed filter media 110 in resiliently-flexible bladder 126, and filtered fluid ‘Z” leaves from the outlet end 701 of apparatus 520. Pressurized water was provided, from reservoir 527 via pump 528 to interstitial area 600 between the exterior of the vessel and the resiliently-flexible bladder 126, to allow further compression of filter media, in an increment of 20 psi, from 0 psi to 40 psi.

Treated fluid ‘Z’ thereafter was flowed to a volumetric free oil knock out 550, which aided in capturing any free oil that is entrained in the outlet stream of the filter, before the filtered fluid ‘Z’ passed to a disposal tank 560. Sample points 529 and b were used to measure oil droplet size and concentration, at both the inlet 700 and the outlet 701 respectively.

The design allowed for allows for fluid pressure to be applied at aperture ‘B” to the interstitial region 600 thus allowing for varying levels of compressibility applied to the filter resiliently-flexible bladder 126.

### Analysis and Findings

Pore volume and porosity testing was conducted to confirm the effect of increasing the amount of compression of the filter media, and thus thereby decreasing the pore size (interstitial spaces) within the respective Media A and Media B.

The amount of fluid fill space in each media A and B was first measured. Thereafter, the overburden pressure applied in incremental 10 psi increments, from 0 psi to 100 psi, and the amount of liquid pushed out of the resiliently-flexible bladder containing the respective Media A or Media B was recorded. Knowing the volume of media needed to fill the system, the pore volume and porosity was then calculated as a percentage.

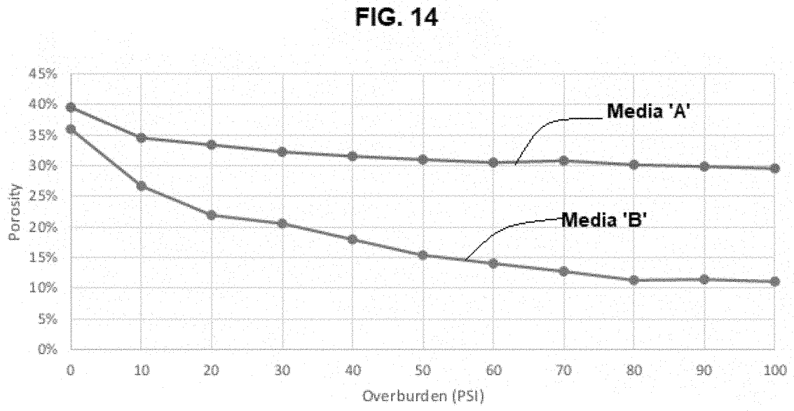

FIG. 14 shows a tabulation of recorded porosity as a percentage of the total volume of the respective media, with supplied overburden pressures extending in 10 psi increments from 0 psi to 100 psi.

As may be seen from FIG. 14, Compressible Media A, being walnut shells of 10-20 mesh, was less compressible, undergoing a reduction in porosity when compressed, from about 40%, to about 30% (i.e. 10%). Compressible Media B, being more compressible, underwent a reduction in porosity from about 35% to 10% (i.e. 25%). Advantageously, as may be seen from FIG. 14, Media B has the ability to have its porosity altered over a wider range using various overburdens.

Using Media A, and measured values for oil concentration at fluid outlet 701 as compared to fluid inlet, over a 24 hour run of contaminated fluid being supplied, the following results were obtained:

TABLE III
Average removal efficiency for Media A at various
porosity reductions

| Overburden Pressure (which | Average Contaminant |
|---|---|
| from FIG. 14 may be calibreated | Removal Efficiency |
| to porosity reduction | (%) |
| 0 psi | <80% |
| 20 psi | 96% |
| 40 psi | 98% |

By reference to FIG. 14 and Table III above, it may be clearly seen that compression of Media A so as to reduce porosity thereof by ˜10% (from 40% to 30%) increased removal efficiency of the filter media 126 by over 18%.

Further similar testing was likewise conducted with both Media B and Media A, but using a constant overburden pressure of 20 psig. Table IV below sets out results obtained as to Average removal efficiency

TABLE IV
48 Hour Run with Media A & B, at 20 psi
OB, 50 ppm oil inlet oil loading

| MEDIA | Avg. Removal Efficiency |
|---|---|
| Media A | 92% |
| Media B | 96% |

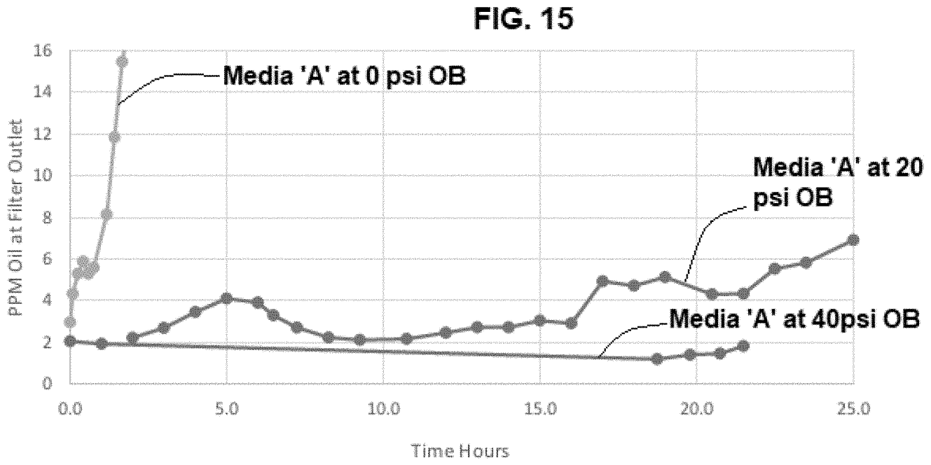

FIG. 15 shows results of a compressible media ‘A’ at various porosity reduction (compression) values obtained using filter overburden pressures of 0 psi, 20 psi, and 40 psi, and the respective contaminant concentration measured at the fluid outlet 701 of filter apparatus 520, as a function of time.

As may be seen from FIG. 15, as media filter compression was increased, and thus filter media porosity and pore size was correspondingly reduced, oil contaminant concentration at fluid outlet 701 decreased. Moreover, for higher compression values of the filter media, the more consistent and steady was the contaminant concentration reduced.

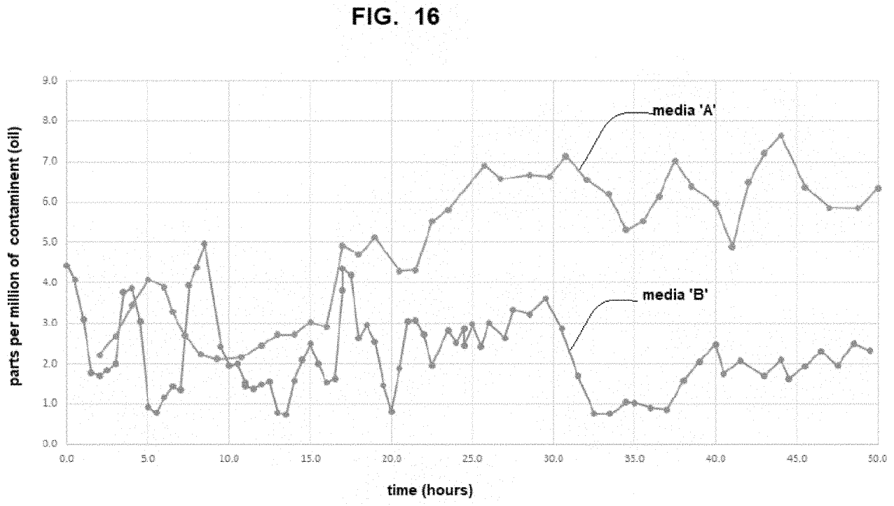

FIG. 16 shows Outlet OIW concentration, in respect to both Media A and Media B, over time, using a constant overburden pressure of 20 psi, which in the case of Media A, from FIG. 14, resulted in an approximate 6% reduction in porosity, and which in the case of Media B resulted in an approximately 12% reduction in porosity.

As may be seen from FIG. 16, Media A averaged 6-7 ppm OIW at the outlet, whereas Media B averaged 2-3 ppm.

In full-scale applications, there is thus a design advantage in implementing the invention and method of the present invention, using a compressible media having a compressibility resulting in a reduction in porosity of ˜10% (in this case 12%), which results in an increased filtration capability capable, at least using these parameters, of a reduction of ˜200-300% in parts per million concentration at a fluid outlet of the compressible media system.

Accordingly, among other things, the test apparatus of FIG. 13 used accordingly established:
that increased compression of a compressible filter medium can produce not only a significant decrease in porosity, but a substantial decrease in the parts per million of contaminant at the filter outlet;
that increased compression of a compressible filter medium, thus reducing to a greater degree the pore size in a filter medium, can make the concentration not only more reduced, but more consistently reduced over longer periods of time;
that using a more easily-compressible medium as the filter medium having a greater degree of compressibility and thus more uniformly compressible can result in, all other conditions being equal, an increase in the average removal efficiency and a greater reduction in parts per million contaminant at the filter outlet; and
that using a more easily-compressible medium as the filter medium having a greater degree of compressibility and thus more uniformly compressible can result, all other conditions being equal, in not only a reducing parts per million contaminant at the filter outlet, but maintain such reduction in concentration of contaminant at the fluid exiting the fluid outlet over a greater interval of time.

What is claimed is:

1. A filtering apparatus comprising:
a volume-changeable filtering chamber having one or more flexible enclosing walls and containing therein a compressible porous filtering medium;
a fluid inlet coupled to the filtering chamber for introducing an input fluid stream with impurities into the filtering chamber;
a fluid outlet coupled to the filtering chamber for discharging a filtered fluid stream from the filtering chamber; and
a volume-changing structure coupled to or in association with the volume-changeable filtering chamber, adapted to permit increasing or decreasing of the volume of the volume-changeable filtering chamber so as to compress or decompress the compressible porous filtering medium therein so as to correspondingly decrease or increase the pore size of the compressible porous filtering medium in said filtering chamber.

2. The filtering apparatus of claim 1, wherein said volume-changeable filtering chamber comprises a thin, resiliently flexible, substantially impermeable elongate bladder contained within said filtering chamber.

3. The filtering apparatus of claim 1, wherein said volume-changing structure further comprises:
a vessel comprising the volume-changeable filtering chamber with the fluid inlet and the fluid outlet extending out of the vessel;
wherein the vessel comprises:
a pressure-adjustment medium in an annulus between the filtering chamber and the vessel; and
a pressure-adjustment port in fluid communication with the annulus between the filtering chamber and the vessel for adjusting the pressure of the pressure-adjustment medium.

4. The filtering apparatus as claimed in any one of claims 1 to 3, wherein the pressure-adjustment medium is a fluid.

5. The filtering apparatus as claimed in any one of claims 1 to 3, wherein the compressible porous filter medium is a filter medium selected from the group of filter mediums consisting of crushed walnut shells, activated carbon, and an extrusion blown moldable thermoplastic vulcanatizate.

6. The filtering apparatus as claimed in claim 1, wherein:
(i) the volume-changing structure comprises at least one moveable piston, and the volume of said volume-changing structure may be changed by movement of said piston,

7. The filtering apparatus as claimed in claim 6, further wherein:
(ii) said volume-changeable filtering chamber comprises an elongate bladder formed of a resiliently-flexible material; and
(iii) said elongate bladder is situated in said volume-changing structure.

8. A method of filtering a fluid containing a contaminant, comprising the steps of:
(i) applying a pressure to an exterior of an elongate resiliently-flexible bladder containing therewithin a compressible filtering medium, so as to compress said compressible filtering medium;
(ii) directing a contaminant-laden fluid stream into an inlet end of said resiliently-flexible bladder, and causing filtered fluid to exit an outlet end of said resiliently-flexible bladder;
(ii) when desired to flush said compressed filter media, reducing pressure applied to an exterior of said resiliently-flexible bladder and thus reducing pressure applied to said filter media in said resiliently-flexible bladder and permitting said compressible media in said resiliently-flexible bladder to expand; and
(iii) directing a flushing fluid into said outlet end of said resiliently-flexible bladder and causing said flushing fluid to exit said inlet end of said resiliently-flexible bladder.

9. The method as claimed in claim 8, wherein the step of reducing pressure to said resiliently-flexible bladder comprises reducing a pressure of fluid which is supplied to a region surrounding an exterior of said resiliently-flexible bladder.

10. The method as claimed in claim 8, wherein the step of reducing pressure to said elongate hollow bladder comprises the step of reducing a force that a moveable piston is applying against a portion of said resiliently-flexible bladder.

11. A method of filtering a fluid containing a contaminant, comprising the steps of:
(i) applying a pressure to an exterior of an elongate resiliently-flexible bladder containing therewithin a compressible filtering medium, so as to compress said compressible filtering medium;
(ii) directing a contaminant-laden fluid stream into an inlet end of said resiliently-flexible bladder, and causing filtered fluid to exit an outlet end of said resiliently-flexible bladder;
(ii) when desired to reduce a concentration of contaminant in said contaminant-laden fluid stream, increasing pressure applied to about an exterior of said resiliently-flexible bladder and thus increase pressure applied to said filter media in said resiliently-flexible bladder so as to further compress said filter media in said resiliently-flexible bladder.

12. The method of claim 11, wherein the increased pressure applied to an exterior of the resiliently-flexible bladder decreases its porosity by at least 10%.
